(19) United States
(12) Patent Application Publication
(10) Pub. No.: US 2017/0094454 A1
(43) Pub. Date: Mar. 30, 2017

(54) EFFICIENCY CROWDSOURCING OF WIRELESS NETWORK-RELATED DATA

(71) Applicant: QUALCOMM Incorporated., San Diego, CA (US)

(72) Inventor: Rayman W. Pon, Cupertino, CA (US)

(21) Appl. No.: 14/866,827

(22) Filed: Sep. 25, 2015

(51) Int. Cl. H04W 4/02; H04B 17/318; H04W 64/00

(52) U.S. Cl. CPC H04W 4/02; H04W 64/00; H04B 17/318

(57) ABSTRACT

Example methods, apparatuses, or articles of manufacture are disclosed herein that may be utilized, in whole or in part, to facilitate or support one or more operations or techniques for improved efficiency crowdsourcing of wireless network-related data, such as for use in or with a mobile communication device, for example.

### BACKGROUND

1. Field

The present disclosure relates generally to position or location estimations of mobile communication devices and, more particularly, to improved efficiency crowdsourcing of wireless network-related data for use in or with mobile communication devices.

2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or the like may assist users in estimating their geographic locations by providing positioning assistance data obtained or gathered from various systems. For example, in some instances, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless communications network. Acquired wireless signals may, for example, be processed by or at a mobile communication device, and its location may be estimated using known techniques, such as Advanced Forward Link Trilateration (AFLT), Observed Time Difference of Arrival (OTDOA), base station identification, or the like.

At times, wireless network-related data, such as to facilitate or support location estimates of mobile communication devices via AFLT, OTDOA, or like techniques, for example, may be collected in some manner, such using one or more crowdsourcing approaches. Collected data may, for example, be accumulated or stored in a suitable database, which may be associated with a location-based service (LBS), wireless communications service provider, or the like. A database may comprise, for example, locations (e.g., latitude-longitude coordinates, etc.), identifies (unique identification numbers, etc.) of wireless transmitters. Wireless network-related data may, for example, be provided to mobile communication devices in positioning assistance messages to help or assist with localization. In some instances, however, a data collection process, such as via crowdsourcing, for example, may significantly tax available resources, such as bandwidth in wireless communication links, memory space, battery life, etc. of mobile communication devices, etc., may increase cellular data usage, associated costs or data charges, or the like.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process that may be performed to facilitate or support techniques for improved efficiency crowdsourcing of wireless network-related data.

FIG. 3 is a schematic diagram illustrating an implementation of an example computing environment associated with a mobile device.

FIG. 4 is a schematic diagram illustrating an implementation of an example computing environment associated with a server.

### SUMMARY

Example implementations relate to techniques for selective crowdsourcing of location-related data. In one implementation, a method may comprise obtaining an observation of a wireless transceiver based, at least in part, on one more signals transmitted by the wireless transceiver and received at the mobile device; if the observation is obtained within time period of a position fix of sufficient accuracy, transmitting one or more messages to a server, the one or more messages comprising the observation with an estimated location of the mobile device determined based, at least in part, on the position fix; and, if the observation is not obtained within the time period of the position fix of sufficient accuracy, limiting transmission of the observation to the server based, at least part, on one or more parameters stored in a memory of the mobile device.

In another implementation, an apparatus may comprise means for obtaining an observation of a wireless transceiver based, at least in part, on one more signals transmitted by the wireless transceiver and received at a mobile device; if the observation is obtained within a time period of a position fix of sufficient accuracy, means for transmitting one or more messages to a server, the one or more messages comprising the observation with an estimated location of the mobile device determined based, at least in part, on the position fix; and if the observation is not obtained within the time period of the position fix of sufficient accuracy, means for limiting transmission of the observation to the server based, at least part, on one or more parameters stored in a memory of the mobile device.

In yet another implementation, an apparatus may comprise a mobile device comprising a wireless transceiver to communicate with an electronic communications network; and one or more processors coupled to a memory to obtain an observation of a wireless transceiver based, at least in part, on one more signals transmitted by the wireless transceiver and received at the mobile device; if the observation is obtained within a time period of a position fix of sufficient accuracy, transmit one or more messages to a server, the one or more messages comprising the observation with an estimated location of the mobile device determined based, at least in part, on the position fix; and, if the observation is not obtained within the time period of the position fix of sufficient accuracy, limit transmission of the observation to the server based, at least part, on one or more parameters stored in a memory of the mobile device.

In yet another implementation, an article may comprise a non-transitory storage medium having instructions executable by a processor to obtain an observation of a wireless transceiver based, at least in part, on one more signals transmitted by the wireless transceiver and received at a mobile device; if the observation is obtained within a time period of a position fix of sufficient accuracy, transmit one or more messages to a server, the one or more messages comprising the observation with an estimated location of the mobile device determined based, at least in part, on the position fix; and, if the observation is not obtained within the time period of the position fix of sufficient accuracy, limit transmission of the observation to the server based, at least part, on one or more parameters stored in a memory of the mobile device. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations or techniques for improved efficiency crowdsourcing of wireless network-related data. As will be seen, in some instances, wireless network-related data may include observations of wireless transceivers, such as, for example, base station transceivers, access points, or the like. In this context, “observation” refers to a measured attribute or characteristic of a wireless signal transmitted by a wireless transceiver and acquired by an observing receiver at a mobile device. For example, an observation may include one or more wireless transceiver identifiers, such as cellular identification numbers (Cell IDs), access point identifiers, etc., transmission power levels, characteristics of wireless signals (e.g., received signal strength, time of arrival, time of flight, angle of arrival, etc.), etc. obtained from wireless signals detected or acquired from wireless transceivers. At times, one or more observations of wireless transceivers may, for example, be paired or correlated with a position fix obtained within a certain time period of such observations, such as if the position fix meets or exceeds some accuracy threshold. As discussed below, these one or more observations may be part of wireless network-related data. In some instances, one or more observations of wireless transceivers may, for example, be paired or correlated with a substantially contemporaneous GNSS position fix of an observing mobile communication device and may also be part of wireless network-related data, as will also be seen.

As used herein, “mobile device,” “mobile communication device,” “crowdsourcing device,” “location-aware mobile device,” or like terms may be used interchangeably and may refer to any kind of special purpose computing platform or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, or the like. It should be appreciated, however, that these are merely examples of mobile devices that may be used, at least in part, to implement one or more operations or techniques for improved efficiency crowdsourcing of wireless network-related data, and that claimed subject matter is not limited in this regard. It should also be noted that the terms “position” and “location” may be used interchangeably herein.

As alluded to previously, at times, to facilitate or support positioning in an area or region of interest, it may be useful to develop a relatively comprehensive or otherwise sufficient database of associated wireless transceivers, such as base station transceivers, radio beacons (e.g., IEEE 802.11 std. wireless local area network (WLAN, etc.) access points, etc.), or the like. A dedicated survey of associated radio sources may present a number of challenges, such as, for example, simulation or computation costs, time or effort involved, or the like. Thus, as was indicated, in some instances, such as to reduce associated costs, for example, one or more crowdsourcing techniques may be employed, at least in part. In this context, “crowdsource,” “crowdsourcing” or like terms refer to a process of measuring, collecting, generating, communicating, etc. applicable data by one or more agents, clients, or users, such as via co-located mobile devices, for example, while traveling within an area or region of interest. The terms “agent,” “user,” or “client” may be used interchangeably herein and refer to a person, device, or application that may facilitate or support one or more crowdsourcing techniques. For example, at times, agents, clients, or users of mobile devices may execute desired tasks (e.g., collect observations of wireless transceivers, communicate position fixes, etc.) and be rewarded in some manner for doing so. Optionally or alternatively, wireless network-related data may be extracted (e.g., by a server, LBS, etc.), upon authorization, from a location-aware unit, memory, etc. of a mobile device, for example. Depending on an implementation, an area or region of interest may comprise or be associated with an outdoor environment, such as, for example, an open-air venue (e.g., an amphitheater, etc.), partially or substantially enclosed area (e.g., a balcony, urban canyon, etc.), an indoor or like environment (e.g., a building, an area within a building, etc.), etc., or any combination thereof.

Typically, in generating or populating a wireless network-related database with observations of wireless transceivers (e.g., base station transceivers, etc.), such as, for example, while a database is in an empty or not near full state (e.g., a database may be considered full for one carrier, one air interface, etc., but may not be considered full for another carrier, air interface, etc.), a few crowdsourcing approached may be employed, at least in part. One approach may involve crowdsourcing observations, such as collecting and forwarding wireless transceiver identifiers (e.g., Cell IDs, access point identifiers or IDs, etc.) of currently observed wireless transceivers, for example, that were obtained within a certain time period of and/or substantially contemporaneously with a position fix of sufficient accuracy to a suitable server. In this context, a position fix may be considered to be sufficiently accurate if it facilitates or supports identification and/or localization of a currently observed wireless transceiver, for example. In some instances, a position fix may also be considered sufficiently accurate if it is within a certain distance from an actual position of a mobile device, meaning that the standard deviation of the error in an estimated receiver position is within a suitable accuracy threshold value. Such a threshold value may be determined experimentally and may be pre-defined or configured, for example, or otherwise dynamically defined in some manner, depending on a particular application, geographic area, location-based service, atmospheric conditions, type or model of a mobile device, or the like. Thus, in an implementation, a position fix may be considered sufficiently accurate if it meets or exceeds an accuracy threshold value of 1.0 meter, as one possible example, meaning that an estimated position of a mobile device is within 1.0 meter or less from an actual position of the mobile device. In another implementation, a position fix may be considered sufficiently accurate if it meets or exceeds an accuracy threshold value of 5.0 meters, for example. In yet another implementation, an accuracy threshold value of up to 20.0 meters may, for example, be used, at least in part, or otherwise considered. In some instances, a position fix obtained via a GNSS or like system may be considered to be sufficiently accurate.

As used herein, “substantially contemporaneously” may refer to a concept of a mutual temporal reference with respect to two or more signals obtained or acquired in substantially the same period of time. In some instances, a mutual temporal reference may comprise, for example, a signaling sequence in which an acquisition of two or more signals may differ in the amount of time attributable to electronic communication or other signal processing. By way of example but not limitation, substantially contemporaneous signals may, for example, be obtained or acquired within 50 milliseconds or less, a second, a minute, etc. of each other. Claimed subject matter is not so limited, of course. Thus, at times, crowdsourced observations paired or correlated with a position fix of a mobile device obtained from a GNSS within a certain time period of and/or substantially contemporaneously with the observation may, for example, be aggregated and/or stored in some manner, such as in a wireless network-related database for an area or region and may be subsequently provided to mobile devices for localization within the area or region.

In some instances, a time period may be established using a time threshold that may be predefined or dynamically determined. For example, a time threshold may be set at within 30 minutes of the last position fix, just to illustrate one possible implementation.

The time period may be dynamically determined based, at least in part, on a mobile device's movement, accuracy of the last position fix, historical pattern of a mobile device, or any combination thereof. For example, a time threshold may be set to within 30 minutes of the last position fix if a mobile device has not moved, which may be determined based, at least in part, on various approaches, such as Cell IDs from nearby wireless transceivers, fingerprints of wireless signals, using inertial sensors on a mobile device, etc. If a mobile device has moved, however, then a time threshold may be set to 5 minutes, as another possible implementation.

Another approach may involve crowdsourcing observations that are not paired or correlated with position fixes obtained within a certain time period of and/or substantially contemporaneously with one or more position fixes of sufficient accuracy, such as GNSS position fixes, for example. Here, having received such an observation, a server may, for example, communicate with and/or make use of a third party service that provides a latitude-longitude position for a wireless transceiver based, at least in part, on a wireless transceiver identifier (e.g., a Cell ID, access point ID, etc.) obtained from the observation. Using information obtained by a third party service, a server may, for example, be able to populate its database more rapidly since a majority of observations received from mobile devices are not paired or correlated with position fixes (e.g., GNSS, etc.). Once a server has populated its database with parameters or attributes of a wireless transceiver (e.g., a Cell ID, access point ID, location, etc.), however, additional observations of this transceiver that are not paired or correlated with within position fixes obtained within a certain time period of and/or substantially contemporaneously with GNSS position fixes may be extraneous, duplicative, redundant, etc. and, as such, of no or little value. Nevertheless, at times, a server may, for example, continue to receive and/or collect such observations in messages from mobile devices. This may unnecessarily consume operational bandwidth (e.g., operational transconductance amplifier (OTA) bandwidth, etc.), for example, resulting in an increase of cellular data usage, associated costs or data charges, or the like. Collecting, reporting, etc. redundant observations may also needlessly increase power consumption of crowdsourcing mobile devices with limited power resources (e.g., battery-operated, etc.), thus, negatively affecting operating lifetime or overall utility of such devices. In addition, at times, this may also reduce an amount of memory that a mobile device may be capable of using, such as to store subsequent observations that may be of greater value (e.g., observations of new wireless transceivers, observations with GNSS position fixes, etc.), for example. Accordingly, it may be desirable to develop one or more methods, systems, or apparatuses that may implement more robust positioning, such as by facilitating or supporting crowdsourcing of wireless network-related data, for example, while improving power consumption of crowdsourcing mobile devices, reducing associated costs, cellular data charges, or the like.

Thus, as will be described in greater detail below, in an implementation, one or more parameters or attributes, such as wireless transceiver identifiers (e.g., Cell IDs, access point IDs, etc.), for example, of wireless transceivers surrounding a current location of a user of a co-located mobile device may be provided to the mobile device, such as from a suitable network-related database by a suitable server, for example. In this context, a wireless transceiver identifier refers to a unique identification number (e.g., via values, elements, etc.) assigned and/or related to a wireless transceiver, such as a cell or sector covered by a wireless transceiver, such as a base station transceiver, access point, etc., location of a wireless transceiver, such as a base station transceiver, access point, etc., operational characteristics of an associated wireless communications network, or the like. Wireless transceiver identifiers, such as Cell IDs, access point IDs, etc. are generally known and need not be described here in greater detail. One or more parameters or attributes may, for example, be downloaded by a mobile device into a local memory and stored in a mobile device's local database. A mobile device may then reference its local mobile database so as to selectively crowdsource, such as collect and forward to a suitable server, for example, observations of wireless transceivers while traveling within an area or region of interest. Observations paired or correlated with position fixes obtained within a certain time period of and/or substantially contemporaneously with GNSS position fixes may, for example, be collected and forwarded to a server without referencing a mobile device's local database since, in some instances, such wireless network-related data may be considered to be of greater use and/or value. With respect to observations not paired or correlated with position fixes obtained within a certain time period of and/or substantially contemporaneously GNSS position fixes, a mobile device may, for example, crowdsource such data if a currently observed wireless transceiver is not present in a mobile device's local database. A mobile device may also limit transmission of such an observation if, for example, a currently observed wireless transceiver is present in a mobile device's local database, since such presence may indicate that the transceiver has been previously crowdsourced. At times, a mobile device may also crowdsource observations not paired or correlated with position fixes obtained within a certain time period of and/or substantially contemporaneously with GNSS position fixes to determine if a particular wireless transceiver is no longer present or active in an area or region of interest, for example, or to confirm that a particular wireless transceiver is still active within such an area or region, as will also be seen. Thus, as was indicated, at times, improved efficiency crowdsourcing of wireless network-related data may, for example, help to more effectively or efficiently construct or update a database of wireless transceivers, radio beacons, etc. for an area or region of interest, may offer or provide a better crowdsourcing user experience, or the like.

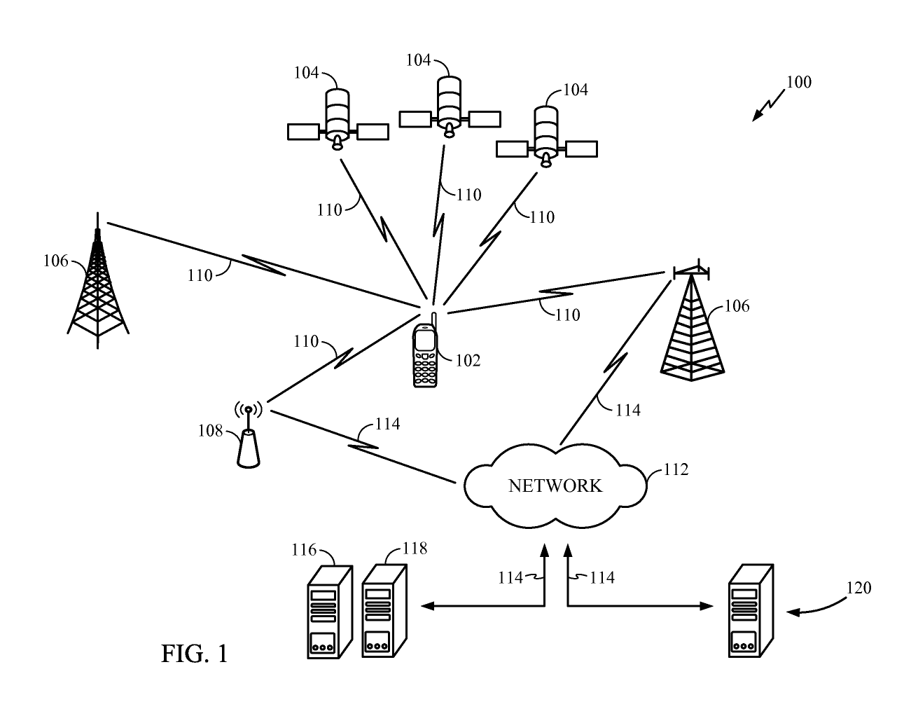

FIG. 1 is a schematic diagram illustrating features associated with an implementation of an example operating environment 100 capable of facilitating or supporting one or more processes or operations for improved efficiency crowdsourcing of wireless network-related data. It should be appreciated that operating environment 100 is described herein as a non-limiting example that may be implemented, in whole or in part, in the context of various electronic communications networks or combination of such networks, such as public networks (e.g., the Internet, the World Wide Web), private networks (e.g., intranets), wireless local area networks (WLAN, etc.), or the like. It should also be noted that claimed subject matter is not limited to outdoor implementations. For example, at times, one or more operations or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations or techniques described herein may be performed, at least in part, in an indoor environment.

As illustrated, operating environment 100 may comprise, for example, one or more satellites 104, one or more wireless transceivers, such as base station transceivers 106, local transceivers 108, etc. capable of communicating with mobile device 102 via communication links 110 in accordance with one or more communication protocols. Satellites 104 may be associated with one or more satellite positioning systems (SPS), such as, for example, the United States Global Positioning System (GPS), the Russian GLONASS system, the European Galileo system, as well as any system that may utilize satellites from a combination of satellite systems, or any satellite system developed in the future. For example, satellites 104 may be from any one of several regional navigation satellite systems (RNSS) such as the Wide Area Augmentation System (WAAS), European Geostationary Navigation Overlay Service (EGNOS), Quasi-Zenith Satellite System (QZSS), etc. Base station transceivers 106, local transceivers 108, etc. may be of the same or similar type, for example, or may represent different types of devices, such as access points, radio beacons, cellular base stations, base station transceivers, femtocells, picocells, or the like, depending on an implementation.

Although not shown, in some instances, operating environment 100 may include, for example, a larger number of base station transceivers 106, local transceivers 108, etc. It should be noted that one or more base station transceivers 106, local transceivers 108, etc. may be capable of transmitting as well as receiving wireless signals. In a particular implementation, one or more local transceivers 108 may be capable of communicating with mobile device 102 at a shorter range than at a range enabled by base station transceiver 106. For example, one or more local transceivers 108 may be positioned in an indoor or like environment, as was indicated. One or more local transceivers 108 may, for example, provide access to a wireless local area network (WLAN, e.g., IEEE std. 802.11 network, etc.) or wireless personal area network (WPAN, e.g., Bluetooth® network, etc.). In another example implementation, one or more local transceivers 108 may comprise, for example, a femtocell or picocell transceiver capable of facilitating or supporting communication within operating environment 100 according to a cellular communication protocol.

In some instances, one or more base station transceivers 106, local transceivers 108, etc. may, for example, be operatively coupled to an electronic communications network 112 that may comprise one or more wired or wireless communications or computing networks capable of providing suitable information, such as via one or more communication links 114, 110, etc. As will be seen, information may include, for example, wireless network-related data, such as locations, identities, transmission power levels, signal-related characteristics, etc. of one or more base station transceivers 106, local transceivers 108, etc., position fixes obtained via a GNSS, one or more messages with signal-related measurements, or any other suitable data, location-related or otherwise, capable of facilitating or supporting one or more operations or processes associated with operating environment 100.

In an implementation, network 112 may be capable of facilitating or supporting communications between suitable computing platforms or devices, such as, for example, mobile device 102, one or more base station transceivers 106, local transceivers 108, as well as one or more servers associated with operating environment 100. In some instances, servers may include, for example, a location server 116, positioning assistance server 118, as well as one or more other servers, indicated generally at 120 (e.g., navigation, information, map, crowdsourcing, etc. server, etc.), capable of facilitating or supporting one or more operations or processes associated with operating environment 100. In a particular implementation, network 112 may comprise, for example, Internet Protocol (IP) infrastructure capable of facilitating a communication between mobile device 102 and servers 116, 118, or 120 via local transceiver 108, base station transceiver 106 (e.g., via a network interface, etc.), or the like. In another implementation, network 112 may comprise cellular communication network infrastructure, such as, for example, a base station controller or master switching center (not shown) to facilitate mobile cellular communications with mobile device 102.

Location server 116 may provide an estimate of a location of mobile device 102 within operating environment 100. A location may, for example, be determined via a GNSS, input provided by an associated user, built-in or remote sensors, radio heat map, range-related measurements, or the like. At times, a location of mobile device 102 may be determined using a proximity to one or more reference points, such as by knowing which base station transceiver 106, local transceiver 108, etc. mobile device 102 is using at a given time. Optionally or alternatively, a location of mobile device 102 may, for example, be determined, at least in part, on mobile device 102 using one or more applicable techniques (e.g., dead reckoning, etc.). In some instances, mobile device 102 may communicate wireless transceiver identifiers (e.g., Cell IDs, access point IDs, MAC addresses, etc.) of one or more base station transceivers 106, local transceivers 108, etc. to a suitable server, and may be provided an electronic digital map of an associated area or region. Mobile device 102 may also, for example, estimate its location based, at least in part, on provided map and locations or base station transceivers 106, local transceivers 108, etc. using one or more appropriate techniques.

Positioning assistance server 118 may, for example, provide positioning assistance data, such as locations, identities, etc. of one or more base station transceivers 106, local transceivers 108, or the like. For example, positioning assistance server 118 may provide locations of one or more base station transceivers 106, local transceivers 108, etc. via a suitable reference frame, such as latitude-longitude, (X, Y, Z) coordinates in three-dimensional Cartesian coordinate space that may be mapped according to a global coordinate system, local coordinate system (e.g., a venue, etc.), etc., just to illustrate a few possible implementations.

Server 120 may comprise, for example, a crowdsourcing server that may be used, at least in part, to facilitate or support any suitable crowdsourcing operation, such as discussed herein. In some instances, server 120 may comprise a map server, for example, that may provide an electronic digital map as well as other positioning assistance data or like information for a particular area or region of interest. At times, an electronic digital map may comprise, for example, locations of one or more base station transceivers 106, local transceivers 108, etc. relative to one or more areas or features (e.g., buildings, streets, etc.) within operating environment 100. Thus, an electronic digital map may, for example, be used, at least in part, to provide additional context to a crowdsourcing user collecting, communicating, etc. wireless network-related data, such as while traveling within an area or region of interest within operating environment 100.

In particular implementations and as discussed herein, mobile device 102 may have circuitry and processing resources capable of measuring, collecting, storing, communicating, etc. suitable data, estimating locations of one or more base station transceivers 106, local transceivers 108, etc., computing a position fix, or the like. For example, mobile device 102 may compute a position fix based, at least in part, on pseudorange measurements acquired from four or more SPS satellites 104. Here, mobile device 102 may compute such pseudorange measurements based, at least in part, on pseudonoise code phase detections in signals 110 acquired from four or more SPS satellites 104, for example. In particular implementations, mobile device 102 may receive from servers 116, 118, or 120 positioning assistance data to aid in the acquisition of signals transmitted by SPS satellites 104 including, for example, almanac, ephemeris data, Doppler search windows, just to name a few examples.

In other implementations, mobile device 102 may, for example, obtain a position fix by processing signals received from one or more terrestrial wireless transceivers positioned at known fixed locations (e.g., local transceiver 108, base station transceiver 106, etc.) using any one of several techniques such as, for example, advanced forward trilateration (AFLT), observed time difference of arrival (OTDOA), or the like. In these particular techniques, a range from mobile device 102 may be measured to three or more of such transceivers based, at least in part, on pilot signals transmitted by the transceivers and received at mobile device 102. In some instances, locations or identities (e.g., a Cell ID, access point ID, MAC address, etc.) of one or more base station transceivers 106, local transceivers 108, etc. in a particular area associated with operating environment 100 may be provided by servers 116, 118, or 120 in the form of a base station almanac (BSA).

In at least one implementation, mobile device 102 may obtain a position fix by measuring or applying characteristics of acquired signals to a radio heatmap indicating expected RSSI, RTT, or like signatures at particular locations in an area or region of interest. In particular implementations, a radio heatmap may associate identities of one or more local transceivers 108 (e.g., a MAC address, which is discernible from a signal acquired from a local transceiver, etc.), expected RSSI from signals transmitted by the identified local transceivers, an expected RTT from the identified transceivers, means or standard deviations from these expected RSSI, RTT, etc. It should be understood, however, that these are merely examples to which claimed subject matter is not limited.

Even though a certain number of computing platforms or devices are illustrated herein, any number of suitable computing platforms or devices may be implemented to facilitate or otherwise support one or more techniques or processes associated with operating environment 100. For example, at times, network 112 may be coupled to one or more wired or wireless communications networks (e.g., WLAN, etc.) so as to enhance a coverage area for communications with mobile device 102, one or more base station transceivers 106, local transceivers 108, servers 116, 118, 120, or the like. In some instances, network 112 may facilitate or support femtocell or picocell-based operative regions of coverage, for example. Again, these are merely example implementations, and claimed subject matter is not limited in this regard.

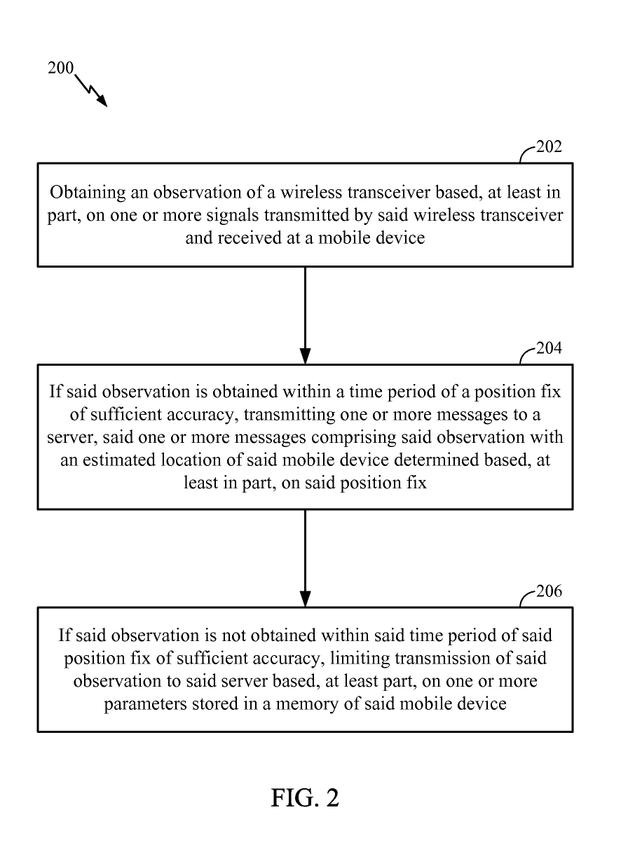

With this in mind, attention is now drawn to FIG. 2, which is a flow diagram illustrating an implementation of an example process 200 that may be performed, in whole or in part, to facilitate or support one or more operations or techniques for improved efficiency crowdsourcing of wireless network-related data. As was indicated, at times, process 200 may be implemented, at least in part, by one or more users employing a co-located location-aware mobile device, such as mobile device 102 of FIG. 1, for example. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 200 may, for example, begin at operation 202 with obtaining an observation of a wireless transceiver based, at least in part, on one more signals transmitted by the wireless transceiver and received at a mobile device. As was indicated, while traveling within an area or region of interest, a mobile device may acquire or receive wireless signals from one or more proximate or “visible” wireless transceivers, such as base station transceivers, local transceivers, etc., for example, and may detect and/or decode particular parameters or attributes encoded in the acquired signals. In some instances, parameters or attributes may comprise, for example, identifiers (e.g., Cell IDs, access point IDs, etc.) of currently observed wireless transceivers, received signal strength, time of arrival, time of flight, angle of arrival, round trip time, or like characteristics or aspects of an acquired wireless signal, or the like. At times, parameters or attributes may, for example, be collected, stored, communicated, etc. via a suitable host crowdsourcing application, which may be provided to a user's mobile device by a suitable server, stored locally on a mobile device, etc. A crowdsourcing application may, for example, be activated, launched, downloaded, etc. upon user's entering an area or region of interest, upon request, user input, or the like. Crowdsourcing or related applications are generally known and need not be described here in greater detail.

As was indicated, in some instances, an observation may, for example, be obtained within a certain time period of (and/or substantially contemporaneously with) a position fix of sufficient accuracy, such as a position fix obtained via a GNSS or like SPS, just to illustrate one possible implementation. Thus, with regard to operation 204, if an observation is obtained within a certain time period of (and/or substantially contemporaneously with) a position fix of sufficient accuracy, a mobile device may, for example, transmit one or more messages to a suitable server, the one or more messages comprising the observation with an estimated location of the mobile device determined based, at least in part, on the position fix. It should be noted that these one or more messages may be transmitted separately, such as at the time each wireless transceiver is observed, for example, or periodically, such as in an appropriate batch or grouping at some later time. A server may then combine observations of the mobile device with observations from other mobile devices to characterize in some manner a wireless transceiver in a wireless network-related database. For example, a server may estimate a location of the wireless transceiver based, at least in part, on multiple observations associated with accurately determined locations of observing mobile devices using one or more known and/or appropriate techniques. A server may then store characterizations of wireless transceivers, such as associated wireless transceiver identifiers (e.g., Cell IDs, access point IDs, etc.), locations, transmission power levels, etc., for example, in a wireless network-related database. As was indicated, an observation paired or correlated with a position fix of sufficient accuracy may, for example, be considered to be of greater use and/or value and, as such, may typically be crowdsourced by a mobile device, such as without referencing its local mobile database.

As alluded to previously, in at least one implementation, an observation of a wireless transceiver may, for example, be obtained within a certain time period of an obtained position fix of sufficient accuracy. Such a time period may be determined, at least in part, experimentally and/or may be pre-defined, for example, or otherwise dynamically defined in some manner depending on a particular environment, mobile device, wireless service provider, wireless transceiver, application, or the like. By way of example but not limitation, in one particular simulation or experiment, it appeared that a time period in a range between 3.0 and 5.0 seconds from obtaining a position fix may prove beneficial to facilitate or support one or more operations or techniques for improved efficiency crowdsourcing of wireless network-related data. Of course, details relating to a time period are intended as merely examples to which claimed subject matter is not limited.

At operation 206, if the observation is not obtained within a certain time period of (and/or substantially contemporaneously with) the position fix of sufficient accuracy, a mobile device may, for example, limit transmission of the observation to the server based, at least part, on one or more parameters or attributes stored in a memory of the mobile device. As was indicated, at least one such parameter or attribute may comprise, for example, a wireless transceiver identifier (e.g., a Cell ID, access point ID, etc.) of one or more wireless transceivers surrounding a current location of a user of a co-located crowdsourcing mobile device. These one or more parameters or attributes may be provided to a mobile device, such as from a network-related database by a suitable server, for example, and may be downloaded and/or stored in a mobile device's local database, such as prior to crowdsourcing within an applicable area or region. Thus, while crowdsourcing, a mobile device may reference its local mobile database to determine if a currently observed wireless transceiver is present in the database, such as using its wireless transceiver identifier, just to illustrate one possible implementation. If a currently observed wireless transceiver is not present in a mobile device's local database, which may indicate that the transceiver has not been previously crowdsourced, a mobile device may collect and forward an observation to a suitable server. In turn, a server may leverage a third party service to obtain a location for this wireless transceiver, and may store an identity, location, or like attributes of the transceiver in a wireless network-related database, as was indicated. If, however, it is determined that a currently observed wireless transceiver is present in a mobile device's local database, such as by locating an associated wireless transceiver identifier, for example, a mobile device may infer that the transceiver has been previously crowdsourced, and, as such, a related observation may be redundant or otherwise less useful. In such a case, a mobile device may, for example, refrain from forwarding such an observation to a server so as to conserve associated resources, as was also indicated.

In at least one implementation, instead of or in addition to performing a binary-type decision or approach, such as to forward an observation if a currently observed wireless transceiver is not present in a mobile device's local database or not forward the observation if the transceiver is present in the local database, for example, a mobile device may be capable of making a determination of whether to crowdsource based, at least in part, on some specified threshold or criteria. For example, a server may specify a percentage (e.g., from 0 to 100%) of observations without a GNSS position fix that correspond to wireless transceiver identifiers (e.g., Cell IDs, access point IDs, etc.) present in a mobile local database that may be forwarded to a server. As a way of illustration, such a percentage may, for example, be determined based, at least in part, on a number of observations previously transmitted or uploaded to a server, such as with respect to a particular wireless transceiver, from a particular mobile device, etc. For example, if a number of previously transmitted or uploaded observations is relatively low, then a larger percentage (e.g., 50%, 75%, etc.) of observations may be specified for forwarding to a server. If a number of previously transmitted or uploaded observations is relatively high, however, then a smaller percentage of observations (e.g., 5%, 10%, etc.) may, for example, be specified.

Optionally or alternatively, a time of a last transmission or upload (e.g., via an appropriate timestamp, etc.) may be used, at least in part, or otherwise considered for specifying a percentage of observations without a GNSS position fix that correspond to wireless transceiver identifiers (e.g., Cell IDs, access point IDs, etc.) present in a mobile local database that may be forwarded to a server. Thus, if a previously transmitted or uploaded observation, such as with respect to a particular wireless transceiver, for example, is a few hours, days, etc. old, then another observation, such as with respect to the same wireless transceiver may be precluded from being transmitted or uploaded. If a previously transmitted or uploaded observation is a few weeks, months, etc. old, however, another observation with respect to the same wireless transceiver may, for example, be allowed to be transmitted or uploaded to a server. Likewise, here, a percentage of observations specified for forwarding to a server may, for example, correspond to and/or depend on how much time has passed between related observations. Of course, these are merely details of specifying a percentage of observations, and claimed subject matter is so limited. For example, at times, a server may specify a percentage (e.g., from 0 to 100%) of mobile devices to transmit observations without a GNSS position fix, such as with respect to a particular wireless transceiver, just to illustrate another possible implementation.

In some instances, specifying a percentage of observations may, for example, facilitate or support a timely detection of changes within a wireless communications network, such as if a wireless transceiver has been relocated, deactivated, renumbered (e.g., a Cell ID, access point ID, etc.), retired, or the like. For example, a lack of observations over a time period with respect to a particular wireless transceiver expected to be observed within a particular area or region, such as evidenced via one or more transceiver-related parameters or attributes downloaded into a mobile local database for the area or region, may indicate that the transceiver is no longer active or in use. Thus, if it is inferred or determined that a particular wireless transceiver is no longer on a wireless network, a network-related database may, for example, be updated in a suitable manner, such as by removing the transceiver, such as its wireless transceiver identifier, location, or other suitable attributes or parameters from the network-related database. Likewise, observations forwarded to a server based, at least in part, on some specified criteria (e.g., a percentage of observations without GNSS position fixes, etc.) may also be used, at least in part, to confirm that a particular wireless transceiver is still active or in use in a similar fashion.

At times, instead of or in addition to a specified percentage, a criteria for forwarding observations with or without GNSS position fixes may, for example, be based, at least in part, on availability of network or server-related resources, such as whether a wireless network-related database is in an empty or full state (or any state in-between), whether a certain crowdsourced area or region, wireless carrier, particular type, make, or model of a crowdsourcing mobile device, etc. is more preferable, or the like. For example, in some instances, a transmission of an observation obtained within a certain time period of (and/or substantially contemporaneously with) a position fix of sufficient accuracy may be limited (e.g., by a mobile device, applicable server, etc.) based, at least in part, on a degree of fullness of a wireless network-related database, such as expressed via a suitable threshold value. Such a threshold value may be determined experimentally and may be pre-defined or configured, for example, or otherwise dynamically defined in some manner, depending on a particular application, geographic area, crowdsourcing parameters, type or model of a mobile device, general location of a mobile device, or the like. By way of example but not limitation, in one particular simulation or experiment, a threshold value of 90% was used, meaning that a mobile device will not transmit, or will limit its transmissions to a certain percentage, observations obtained within a certain time period of (and/or substantially contemporaneously with) a position fix of sufficient accuracy and/or a crowdsourcing server will not accept, or will limit its acceptances to a certain percentage, observations if a wireless network-related database is assessed to be at 90% of its capacity.

In some instances, however, such as if a database is in a near full state, for example, a mobile device may still be capable of transmitting and/or a server may still be capable of accepting such an observation, which may depend on a particular application, geographic area, crowdsourcing parameters, type or model of a mobile device, or the like. Claimed subject matter is not so limited, of course. For example, in at least one implementation, a transmission of an observation obtained within a certain time period of (and/or substantially contemporaneously with) a position fix of sufficient accuracy may be limited (e.g., by a mobile device, applicable server, etc.) based, at least in part, on a list of wireless transceivers located in a general area of a mobile device and from which one or more such observations have been previously obtained. Depending on an implementation, such a list may be stored, for example, in a mobile device's local memory or database, applicable server, or any combination thereof (e.g., partial lists, etc.). Here, a mobile device may, for example, access and/or reference such a list and may match one or more identifiers of one or more currently observed wireless transceivers (e.g., a Cell ID, access point ID, etc.) with one or more identifiers of wireless transceivers stored in the list, just to illustrate one possible implementation. Thus, in some instances, such as having found a match, for example, a mobile device may refrain from transmitting an obtained observation, such as to avoid redundancy and/or duplication of measurements. It should be noted that various other or like matching operations (e.g., RSSI matching, etc.), such as to identify one or more wireless transmitters near or proximate to a location of a mobile device may be used herein, in whole or in part.

As was indicated, it should be noted that even though certain aspects or features of one or more operations or techniques for improved efficiency crowdsourcing of wireless network-related data are described herein in connection with a cellular communications network, wireless transceiver, etc., one or more operations or techniques may be implemented, at least in part, in connection with any suitable wireless communications network and/or device. For example, in some instances, a wireless local area network (WLAN, e.g., IEEE std. 802.11 network, etc.), wireless personal area network (WPAN, e.g., Bluetooth® network, etc.), etc. utilizing one or more access points, femtocells, picocells, or the like may be employed, at least in part, or otherwise considered. At times, any suitable combination of these or other like wireless networks and/or devices may also be used, in whole or in part.

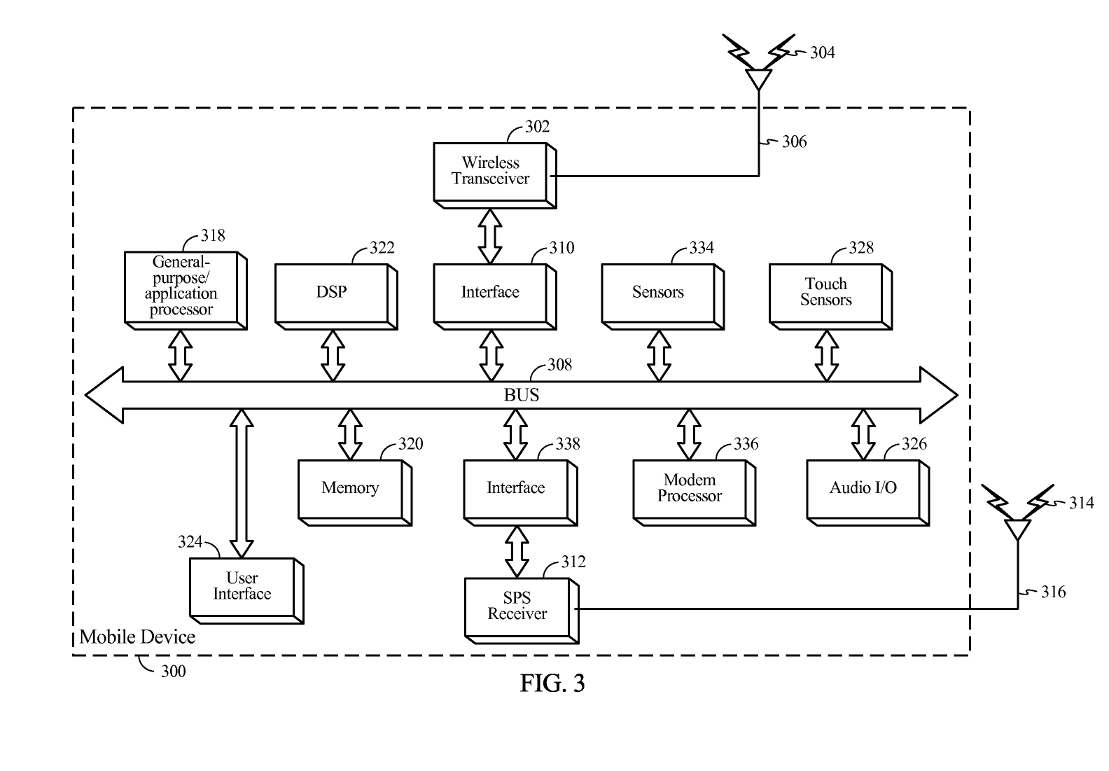

FIG. 3 is a schematic diagram of an implementation of an example computing environment associated with a mobile device that may be used, at least in part, to facilitate or support one or more operations or techniques for improved efficiency crowdsourcing of wireless network-related data. An example computing environment may comprise, for example, a mobile device 300 that may include one or more features or aspects of mobile device 102 of FIG. 1, though claimed subject matter is not so limited. For example, in some instances, mobile device 300 may comprise a wireless transceiver 302 capable of transmitting or receiving wireless signals, referenced generally at 304, such as via an antenna 306 over a suitable wireless communications network. Wireless transceiver 302 may, for example, be capable of sending or receiving one or more suitable communications, such as one or more communications discussed with reference to FIG. 2, as one possible example.

By way of example but not limitation, in some instances, wireless transceiver 302 may comprise, for example, or be representative of means for obtaining an observation of a wireless transceiver based, at least in part, on one more signals transmitted by the wireless transceiver and received at mobile device 300, such as to implement operation 202 of FIG. 2, at least in part. In addition, in at least one implementation, wireless transceiver 302 may be representative of or comprise means for transmitting one or more messages to a server, such as if the observation is obtained within a certain time period of (and/or substantially contemporaneously with) a position fix of sufficient accuracy, for example, one or more messages comprising the observation with an estimated location of mobile device 300 determined based, at least in part, on the position fix, such as to implement operation 204 of FIG. 2, at least in part. Also, in some instances, wireless transceiver 302 may be representative of or comprise means for limiting transmission of the observation to the server based, at least part, on one or more parameters stored in a memory of mobile device 300, such as if the observation is not obtained within a certain time period of (and/or substantially contemporaneously with) the position fix of sufficient accuracy, for example, such as to implement operation 206 of FIG. 2, at least in part.

Wireless transceiver 302 may, for example, be coupled or connected to a bus 308 via a wireless transceiver bus interface 310. Depending on an implementation, at times, wireless transceiver bus interface 310 may, for example, be at least partially integrated with wireless transceiver 302. Some implementations may include multiple wireless transceivers 302 or antennas 306 so as to enable transmitting or receiving signals according to a corresponding multiple wireless communication standards such as Wireless Fidelity (WiFi), Code Division Multiple Access (CDMA), Wideband-CDMA (W-CDMA), Long Term Evolution (LTE), Bluetooth®, just to name a few examples.

In an implementation, mobile device 300 may, for example, comprise an SPS or like receiver 312 capable of receiving or acquiring one or more SPS or other suitable wireless signals 314, such as via an SPS or like antenna 316. SPS receiver 312 may process, in whole or in part, one or more acquired SPS signals 314 for estimating a location of mobile device 300. In some instances, one or more general-purpose application processors 318 (henceforth referred to as “processor”), memory 320, digital signal processor(s) (DSP) 322, or like specialized devices or processors not shown may be utilized to process acquired SPS signals 314, in whole or in part, calculate a location of mobile device 300, such as in conjunction with SPS receiver 312, or the like. Storage of SPS or other signals for implementing one or more positioning operations, such as in connection with one or more techniques for improved efficiency crowdsourcing of wireless network-related data, for example, may be performed, at least in part, in memory 320, suitable registers or buffers (not shown).

Although not shown, it should be appreciated that in at least one implementation one or more processors 318, memory 320, DSPs 322, or like specialized devices or processors may comprise one or more processing modules capable of obtaining an observation of a wireless transceiver based, at least in part, on one more signals transmitted by the wireless transceiver and received at mobile device 300; if the observation is obtained within a certain time period of (and/or substantially contemporaneously with) a position fix of sufficient accuracy, transmitting one or more messages to a server, the one or more messages comprising the observation with an estimated location of mobile device 300 determined based, at least in part, on the position fix; and, if the observation is not obtained within a certain time period of (and/or substantially contemporaneously with) the position fix of sufficient accuracy, limiting transmission of the observation to the server based, at least part, on one or more parameters stored in a memory of mobile device 300.

It should be noted that all or part of one or more processing modules may be implemented using or otherwise including hardware, firmware, software, or any combination thereof. Processing modules may be representative of one or more circuits capable of performing at least a portion of information computing technique or process. By way of example but not limitation, processor 318 or DSP 322 may include one or more processors, controllers, microprocessors, microcontrollers, application specific integrated circuits, digital signal processors, programmable logic devices, field programmable gate arrays, or the like, or any combination thereof. Thus, at times, processor 318 or DSP 322 or any combination thereof may comprise or be representative of means for limiting transmission of the observation to the server based, at least part, on one or more parameters stored in a memory of mobile device 300, such as if the observation is not obtained within a certain time period of (and/or substantially contemporaneously with) the position fix of sufficient accuracy, as illustrated in or described with respect to operation 206 of FIG. 2, for example.

As illustrated, DSP 322 may be coupled or connected to processor 318 and memory 320 via bus 308. Although not shown, in some instances, bus 308 may comprise one or more bus interfaces that may be integrated with one or more applicable components of mobile device 300, such as DSP 322, processor 318, memory 320, or the like. In various embodiments, one or more operations or functions described herein may be performed in response to execution of one or more machine-readable instructions stored in memory 320, such as on a computer-readable storage medium, such as RAM, ROM, FLASH, disc drive, etc., just to name a few examples. Instructions may, for example, be executable via processor 318, one or more specialized processors not shown, DSP 322, or the like. Memory 320 may comprise a non-transitory processor-readable memory, computer-readable memory, etc. that may store software code (e.g., programming code, instructions, etc.) that may be executable by processor 318, DSP 322, or the like to perform operations or functions described herein.

Mobile device 300 may comprise a user interface 324, which may include any one of several devices such as, for example, a speaker, microphone, display device, vibration device, keyboard, touch screen, etc., just to name a few examples. In at least one implementation, user interface 324 may enable a user to interact with one or more applications hosted on mobile device 300. For example, one or more devices of user interface 324 may store analog or digital signals on memory 320 to be further processed by DSP 322, processor 318, etc. in response to input or action from a user. Similarly, one or more applications hosted on mobile device 300 may store analog or digital signals in memory 320 to present an output signal to a user. In some implementations, mobile device 300 may optionally include a dedicated audio input/output (I/O) device 326 comprising, for example, a dedicated speaker, microphone, digital to analog circuitry, analog to digital circuitry, amplifiers, gain control, or the like. It should be understood, however, that this is merely an example of how audio I/O device 326 may be implemented, and that claimed subject matter is not limited in this respect. As seen, mobile device 300 may comprise one or more touch sensors 328 responsive to touching or like pressure applied on a keyboard, touch screen, or the like.

Mobile device 300 may comprise one or more sensors 334 coupled or connected to bus 308, such as, for example, one or more inertial sensors, ambient environment sensors, or the like. Inertial sensors of sensors 334 may comprise, for example, one or more accelerometers (e.g., collectively responding to acceleration of mobile device 300 in one, two, or three dimensions, etc.), gyroscopes or magnetometers (e.g., to support one or more compass or like applications, etc.), etc., just to illustrate a few examples. Ambient environment sensors of mobile device 300 may comprise, for example, one or more barometric pressure sensors, temperature sensors, ambient light detectors, camera sensors, microphones, etc., just to name few examples. Sensors 334 may generate analog or digital signals that may be stored in memory 320 and may be processed by DSP 322, processor 318, etc., such as in support of one or more applications directed to positioning or navigation operations, wireless communications, radio heat map learning, video gaming or the like.

In a particular implementation, mobile device 300 may comprise a modem processor 336, dedicated or otherwise, capable of performing baseband processing of signals received or downconverted via wireless transceiver 302, SPS receiver 312, or the like. Similarly, modem processor 336 may perform baseband processing of signals to be upconverted for transmission via wireless transceiver 302, for example. In alternative implementations, instead of having a dedicated modem processor, baseband processing may be performed, at least in part, by processor 318, DSP 322, or the like. In addition, in some instances, an interface 338, although illustrated as a separate component, may be integrated, in whole or in part, with one or more applicable components of mobile device 300, such as bus 308 or SPS receiver 312, for example. Optionally or alternatively, SPS receiver 312 may be coupled or connected to bus 308 directly. It should be understood, however, that these are merely examples of components or structures that may perform baseband processing, and that claimed subject matter is not limited in this regard.

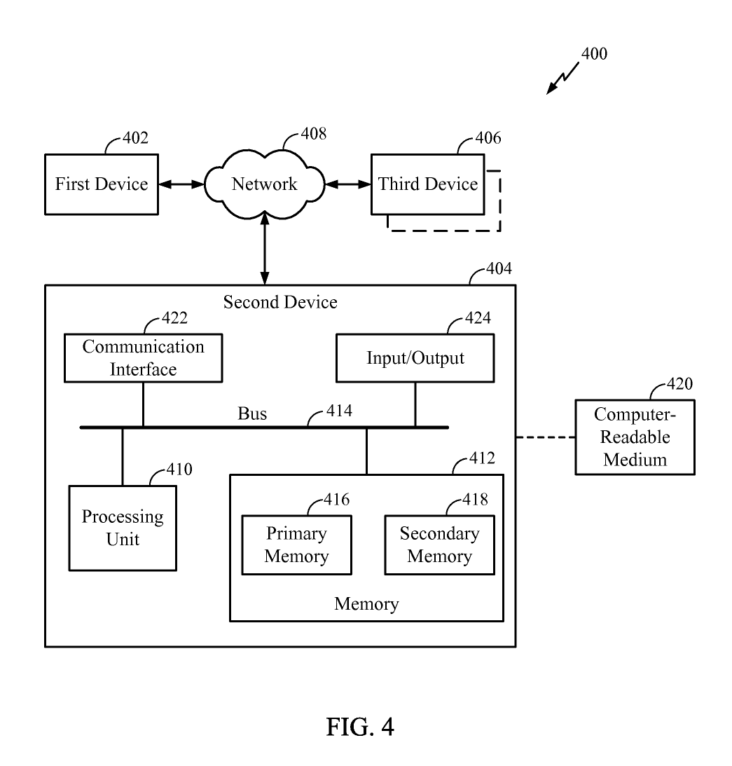

FIG. 4 is a schematic diagram illustrating an implementation of an example computing environment or system 400 that may be associated with or include one or more servers or other devices capable of partially or substantially implementing or supporting one or more operations or techniques for improved efficiency crowdsourcing of wireless network-related data, such as discussed above in connection with FIGS. 1-3, for example. Computing environment 400 may include, for example, a first device 402, a second device 404, a third device 406, etc., which may be operatively coupled together via a communications network 408. In some instances, first device 402 may comprise a server capable of providing positioning assistance messages, such as comprising, for example, identities, locations, etc. of wireless transceivers, radio heat map, base station almanac, or the like. For example, first device 402 may also comprise a server capable of providing an electronic digital map to a mobile device based, at least in part, on a coarse or rough estimate of a location of the mobile device, upon request, or the like. First device 402 may also comprise a server capable of providing any other suitable wireless network-related data. Second device 404 or third device 406 may comprise, for example, mobile devices, though claimed subject matter is not so limited. For example, in some instances, second device 404 may comprise a server functionally or structurally similar to first device 402, just to illustrate another possible implementation. In addition, communications network 408 may comprise, for example, one or more wireless transceivers, such as access points, femtocells, picocells, or the like. Of course, claimed subject matter is not limited in scope in these respects.

First device 402, second device 404, or third device 406 may be representative of any device, appliance, platform, or machine that may be capable of exchanging information over communications network 408. By way of example but not limitation, any of first device 402, second device 404, or third device 406 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 402, 404, and 406, respectively, may comprise one or more of a mobile device, wireless transmitter and/or receiver (e.g., a transceiver), server, etc. in accordance with example implementations described herein.

In an implementation, communications network 408 may be representative of one or more communication links, processes, or resources capable of supporting an exchange of information between at least two of first device 402, second device 404, or third device 406. By way of example but not limitation, communications network 408 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 406, there may be additional like devices operatively coupled to communications network 408. It is also recognized that all or part of various devices or networks shown in computing environment 400, or processes or methods, as described herein, may be implemented using or otherwise including hardware, firmware, software, or any combination thereof.

By way of example but not limitation, second device 404 may include at least one processing unit 410 that may be operatively coupled to a memory 412 via a bus 414. Processing unit 410 may be representative of one or more circuits capable of performing at least a portion of a suitable computing procedure or process. For example, processing unit 410 may include one or more processors, controllers, microprocessors, microcontrollers, application specific integrated circuits, digital signal processors, programmable logic devices, field programmable gate arrays, or the like, or any combination thereof.

Memory 412 may be representative of any information storage mechanism or appliance. Memory 412 may include, for example, a primary memory 416 and a secondary memory 418. Primary memory 416 may include, for example, a random access memory, read only memory, etc. While illustrated in this example as being separate from processing unit 410, it should be understood that all or part of primary memory 416 may be provided within or otherwise co-located/coupled with processing unit 410. Secondary memory 418 may include, for example, same or similar type of memory as primary memory or one or more information storage devices or systems, such as, for example, a disk drive, an optical disc drive, a tape drive, a solid state memory drive, etc. In certain implementations, secondary memory 418 may be operatively receptive of, or otherwise configurable to couple to, a computer-readable medium 420. Computer-readable medium 420 may include, for example, any non-transitory storage medium that may carry or make accessible information, code, or instructions for one or more of devices in computing environment 400. Computer-readable medium 420 may also be referred to as a storage medium.

Second device 404 may include, for example, a communication interface 422 that may provide for or otherwise support an operative coupling of second device 404 to at least communications network 408. By way of example but not limitation, communication interface 422 may include a network interface device or card, a modem, a router, a switch, a transceiver, and the like. Second device 404 may also include, for example, an input/output device 424. Input/output device 424 may be representative of one or more devices or features that may be configurable to accept or otherwise introduce human or machine inputs, or one or more devices or features that may be capable of delivering or otherwise providing for human or machine outputs. By way of example but not limitation, input/output device 424 may include an operatively configured display, speaker, keyboard, mouse, trackball, touch screen, information port, or the like.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units de-signed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, messages, parameters, frames, packets, content and/or the like. It should be understood, however, that all of these and/or similar terms are to be associated with appropriate physical quantities or manifestations, and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. Likewise, operation of a memory device to store bits, values, elements, symbols, characters, terms, numbers, numerals, measurements, messages, parameters, frames, packets, content and/or the like may comprise a physical transformation. With particular types of memory devices, such a physical transformation may comprise a physical transformation of an article to a different state or thing. For example, but without limitation, for some types of memory devices, a change in state may involve an accumulation and/or storage of charge or a re-lease of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) net-work, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transceiver (e.g., an access point, etc.) may comprise a femtocell or picocell, utilized to extend cellular telephone service into a business or home. In such an implementation, one or more mobile devices may communicate with a femtocell or picocell via a code division multiple access (“CDMA”) cellular communication protocol, for example, and the femtocell or picocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transceivers acting as “pseudolites”, or a combination of SVs and such terrestrial transceivers. Terrestrial transceivers may, for example, include ground-based transceivers that broadcast a PN code or other ranging code (e.g., similar to a GPS or CDMA cellular signal). Such a transceiver may be assigned a unique PN code so as to permit identification by a remote receiver. Terrestrial transceivers may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transceivers acting as pseudolites, equivalents of pseudolites, and possibly others. The terms “SPS signals” and/or “SV signals”, as used herein, is intended to include SPS-like signals from terrestrial transceivers, including terrestrial transceivers acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method at mobile device, comprising:
obtaining an observation of a wireless transceiver based, at least in part, on one or more signals transmitted by said wireless transceiver and received at said mobile device;
if said observation is obtained within a time period of a position fix of sufficient accuracy, transmitting one or more messages to a server, said one or more messages comprising said observation with an estimated location of said mobile device determined based, at least in part, on said position fix; and
if said observation is not obtained within said time period of said position fix of sufficient accuracy, limiting transmission of said observation to said server based, at least part, on one or more parameters stored in a memory of said mobile device.

2. The method of claim 1, wherein said one or more parameters stored in said memory of said mobile device are indicative of whether observations of said base station transceiver have been received at said server.

3. The method of claim 1, wherein said one or more parameters comprise an indication of a presence or an absence of said wireless transceiver in said mobile device's local database.

4. The method of claim 1, wherein said limiting said transmission of said observation further comprises:
determining whether a wireless transceiver identifier for said wireless transceiver is present in said mobile device's local database; and
transmitting said one or more messages to said server based, at least in part, on an absence of said wireless transceiver identifier in said local mobile database.

5. The method of claim 4, wherein said one or more parameters are downloaded into said memory of said mobile device from said server.

6. The method of claim 1, and further comprising:
obtaining a specified criteria for said observation; and
determining a presence or an absence of said wireless transceiver on a wireless communications network based, at least in part, on said specified criteria.

7. The method of claim 6, wherein said specified criteria comprises at least one of the following: a percentage of observations not obtained within said time period of said position fix of sufficient accuracy; a percentage of observations obtained within said time period of said position fix of sufficient accuracy; availability of network or server-related resources; a geographic area or region; a model of said mobile device; a type of said mobile device; a timestamp of a last transmission or upload of said one or more messages to said server; a degree of fullness of a wireless network-related database; or any combination thereof.

8. The method of claim 6, and further comprising updating a wireless network-related database based, at least in part, on said determining said presence or said absence of said wireless transceiver on said wireless communications network.

9. The method of claim 8, wherein said updating said wireless network-related database comprises removing attributes of said wireless transceiver from said wireless network-related database.

10. The method of claim 1, wherein said observation comprises at least one of the following: a wireless transceiver identifier for said wireless transceiver; a transmission power level of said wireless transceiver; a received signal strength measurement of said one or more signals transmitted by said wireless transceiver; a time of arrival measurement of said one or more signals transmitted by said wireless transceiver; a time of flight measurement of said one or more signals transmitted by said wireless transceiver; an angle of arrival measurement of said one or more signals transmitted by said wireless transceiver; a round trip time measurement of said one or more signals transmitted by said wireless transceiver; or any combination thereof.

11. The method of claim 1, wherein said position fix of sufficient accuracy comprises a position fix obtained via a Global Navigation Satellite System (GNSS).

12. The method of claim 1, wherein said wireless transceiver comprises at least one of the following: an IEEE 802.11 std. WLAN access point; a femtocell; a picocell; or any combination thereof.

13. The method of claim 1, wherein said one or more parameters stored in said memory of said mobile device comprise at least one of the following: a wireless transceiver identifier for said wireless transceiver; a location of said wireless transceiver; an estimated location uncertainty of said wireless transceiver; a coverage area of said wireless transceiver; or any combination thereof.

14. The method of claim 1, and further comprising limiting transmission of said observation obtained within said time period of said position fix of sufficient accuracy to said server based, at least in part, on a degree of fullness of a wireless network-related database.

15. An apparatus comprising:
means for obtaining an observation of a wireless transceiver based, at least in part, on one more signals transmitted by said wireless transceiver and received at a mobile device;
if said observation is obtained within a time period of a position fix of sufficient accuracy, means for transmitting one or more messages to a server, said one or more messages comprising said observation with an estimated location of said mobile device determined based, at least in part, on said position fix; and
if said observation is not obtained within said time period of said position fix of sufficient accuracy, means for limiting transmission of said observation to said server based, at least part, on one or more parameters stored in a memory of said mobile device.

16. The apparatus of claim 15, wherein said means for limiting said transmission of said observation further comprises:
means for determining whether a wireless transceiver identifier for said wireless transceiver is present in said mobile device's local database; and
means for transmitting said one or more messages to said server based, at least in part, on an absence of said wireless transceiver identifier in said local mobile database.

17. The apparatus of claim 15, and further comprising:
means for obtaining a specified criteria for said observation; and
means for determining a presence or an absence of said wireless transceiver on a wireless communications network based, at least in part, on said specified criteria.

18. The apparatus of claim 17, wherein said specified criteria comprises at least one of the following: a percentage of observations not obtained within said time period of said position fix of sufficient accuracy; a percentage of observations obtained within said time period of said position fix of sufficient accuracy; availability of network or server-related resources; a geographic area or region; a model of said mobile device; a type of said mobile device; a timestamp of a last transmission or upload of said one or more messages to said server; a degree of fullness of a wireless network-related database; or any combination thereof.

19. The apparatus of claim 17, and further comprising means for updating a wireless network-related database based, at least in part, on said determining said presence or said absence of said wireless transceiver on said wireless communications network.

20. The apparatus of claim 15, wherein said observation comprises at least one of the following: a wireless transceiver identifier for said wireless transceiver; a transmission power level of said wireless transceiver; a received signal strength measurement of said one or more signals transmitted by said wireless transceiver; a time of arrival measurement of said one or more signals transmitted by said wireless transceiver; a time of flight measurement of said one or more signals transmitted by said wireless transceiver; an angle of arrival measurement of said one or more signals transmitted by said wireless transceiver; a round trip time measurement of said one or more signals transmitted by said wireless transceiver; or any combination thereof.

21. The apparatus of claim 15, wherein said one or more parameters stored in said memory of said mobile device comprise at least one of the following: a wireless transceiver identifier for said wireless transceiver; a location of said wireless transceiver; an estimated location uncertainty of said wireless transceiver; a coverage area of said wireless transceiver; or any combination thereof.

22. The apparatus of claim 21, wherein said location of said wireless transceiver is obtained in connection with at least one of the following: a global coordinate system; a local coordinate system; or any combination thereof.

23. An apparatus comprising:
a mobile device comprising:
a wireless transceiver to communicate with an electronic communications network; and
one or more processors coupled to a memory and to said wireless transceiver, wherein said one or more processors configured to:
obtain an observation of a wireless transceiver based, at least in part, on one more signals transmitted by said wireless transceiver and received at said mobile device;
if said observation is obtained within a time period of a position fix of sufficient accuracy, transmit one or more messages to a server, said one or more messages comprising said observation with an estimated location of said mobile device determined based, at least in part, on said position fix; and
if said observation is not obtained within said time period of said position fix of sufficient accuracy, limit transmission of said observation to said server based, at least part, on one or more parameters stored in a memory of said mobile device.

24. The apparatus of claim 23, wherein said one or more processors configured to said limit said transmission of said observation to said server further configured to:
determine whether a wireless transceiver identifier for said wireless transceiver is present in said mobile device's local database; and
transmit said one or more messages to said server based, at least in part, on an absence of said wireless transceiver identifier in said local mobile database.

25. The apparatus of claim 23, wherein said one or more processors further configured to:
obtain a specified criteria for said observation; and
determine a presence or an absence of said wireless transceiver on a wireless communications network based, at least in part, on said specified criteria.

26. The apparatus of claim 25, wherein said specified criteria comprises at least one of the following: a percentage of observations not obtained within said time period of said position fix of sufficient accuracy; a percentage of observations obtained within said time period of said position fix of sufficient accuracy; availability of network or server-related resources; a geographic area or region; a model of said mobile device; a type of said mobile device; a timestamp of a last transmission or upload of said one or more messages to said server; a degree of fullness of a wireless network-related database; or any combination thereof.

27. The apparatus of claim 23, wherein said observation comprises at least one of the following: a wireless transceiver identifier for said wireless transceiver; a transmission power level of said wireless transceiver; a received signal strength measurement of said one or more signals transmitted by said wireless transceiver; a time of arrival measurement of said one or more signals transmitted by said wireless transceiver; a time of flight measurement of said one or more signals transmitted by said wireless transceiver; an angle of arrival measurement of said one or more signals transmitted by said wireless transceiver; a round trip time measurement of said one or more signals transmitted by said wireless transceiver; or any combination thereof.

28. The apparatus of claim 23, wherein said one or more parameters stored in said memory of said mobile device comprise at least one of the following: a wireless transceiver identifier for said wireless transceiver; a location of said wireless transceiver; an estimated location uncertainty of said wireless transceiver; a coverage area of said wireless transceiver; or any combination thereof.

29. An article comprising:
a non-transitory storage medium having instructions executable by a processor to:
obtain an observation of a wireless transceiver based, at least in part, on one more signals transmitted by said wireless transceiver and received at a mobile device;
if said observation is obtained within a time period of a position fix of sufficient accuracy, transmit one or more messages to a server, said one or more messages comprising said observation with an estimated location of said mobile device determined based, at least in part, on said position fix; and
if said observation is not obtained within said time period of said position fix of sufficient accuracy, limit transmission of said observation to said server based, at least part, on one or more parameters stored in a memory of said mobile device.

30. The article of claim 29, wherein said non-transitory storage medium having instructions executable by said processor to said limit said transmission of said observation to said server further includes instructions to:
determine whether a wireless transceiver identifier for said wireless transceiver is present in said mobile device's local database; and
transmit said one or more messages to said server based, at least in part, on an absence of said wireless transceiver identifier in said local mobile database.
